(19) United States
(12) Patent Application Publication
(10) Pub. No.: US 2023/0298048 A1
(43) Pub. Date: Sep. 21, 2023

(54) METHOD FOR SHARING DATA RELATING TO THE MANUFACTURING OF A PRODUCT

(71) Applicant: THALES, COURBEVOIE (FR)

(72) Inventors: François VALENTIN, MOIRANS (FR); Frédéric GAILLARD, MOIRANS (FR)

(21) Appl. No.: 18/004,446

(22) PCT Filed: Jul. 7, 2021
(86) PCT No.: PCT/EP2021/068884

§ 371 Date: Jan. 5, 2023

(30) Foreign Application Priority Data
Jul. 23, 2020 (FR) 2007759

(51) Int. Cl. G06Q 30/018; G06Q 50/04

(52) U.S. Cl. CPC G06Q 30/0185; G06Q 50/04

(57) ABSTRACT

A method for sharing manufacturing data on a product includes a step of receiving data on the manufacturing state of the product, a step of generating new data on the manufacturing state of the product, and a step of transmitting the new state data to at least two RFID tags.

### TECHNICAL FIELD

The present invention relates to a method for sharing manufacturing data on a product, to a system for sharing manufacturing data on a product, and to a computer program product comprising program instructions exploitable by said system for sharing manufacturing data on a product.

### PRIOR ART

It is known to use RFID tags (RFID standing for Radio Frequency IDentification) in manufacturing processes that require a certain level of dematerialization and security and the configuration of the manufactured products of which must be guaranteed. These constraints are particularly present in high-technology fields such as production of products for aeronautical applications, space-technology applications or the medical field. Conventionally, a manufacturing process consists in assembling, in a certain order and depending on their features, various sub-products in various manufacturing operations and manufacturing steps defined during the development and industrialization of the product. Series production involves these various manufacturing operations being faithfully repeated by means of execution management software or any other means allowing the physical characteristics of the produced product to be subsequently compared with specifications in a file defining the product and validated. In the context of products intended for markets that are highly regulated, these products may be accompanied by a bundle of documents proving production and testing has been carried out as required and the origins of the materials used and any other document requested by the customer. Conventionally, a manufacturing process may be generated using production execution monitoring software, such as PLM software (PLM standing for Product Lifecycle Management), ERP software (ERP standing for Enterprise Resource Planning) or MES software (MES standing for Manufacturing Execution System). Such software is able to associate with each production step implementation of any required instructions or plan element. However, this software requires databases of large size. In addition, any change in the physical state of the product is accompanied by a change in the information system, this inducing substantial flows of data between the various machines of the production line. Access to low-cost communicating objects such as RFID tags is increasingly contributing to allowing, in industry, data associated with sub-products to be readily located, identified and borne. Industrial processes have been improved thereby, but use has still not been made of the full potential of these RFID tags.

There is therefore a need to improve methods for sharing manufacturing data on a product using RFID tags while avoiding, at least partially, the need to use production execution monitoring software and while improving traceability, production compliance and the security of the data shared.

### SUMMARY OF THE INVENTION

The present invention aims to at least partially meet this need.

More particularly, the present invention aims to improve how manufacturing data on a product are shared.

A first subject of the invention is a method for sharing manufacturing data on a product, said product being manufactured from various sub-products in various manufacturing operations, each sub-product and/or each manufacturing operation being associated with one RFID tag, each RFID tag comprising data on the manufacturing state of the product. During manufacture of the product, the method comprises:
a step of receiving data on the manufacturing state of the product from the at least two RFID tags;
a step of generating new data on the manufacturing state of the product based on said received state data, said received state data being reorganized in said generating step;
a step of transmitting the new data on the manufacturing state of the product to the at least two RFID tags.

The proposed solution is based on the existence in parallel of physical components for carrying out a production operation and of RFID tags attached to the sub-products, allowing location requests to be responded to but also data to be exchanged. Assembly results in assembly, on one site and in the same time period, of one or more sub-products, but also of the informational image of this assembly transaction. Thus, it is the product in the process of being assembled that bears the information system. The RFID tags contain data on the manufacturing state of the product at a given time. This data on the manufacturing state of the product is updated on each manufacturing operation. The physical and digital assembly operations are in perfect one-to-one correspondence and an operation can no longer be validated if the sub-products have not actually undergone this operation. Transactions with monitoring software are decreased to the bare minimum, this increasing resilience to potential network failures. Furthermore, data on the manufacturing state of the product are generated while limiting interactions with a wide-area network, this providing manufacturing facilities with autonomy and flexibility. Lastly, the production journey is generated iteratively by loading operations in step N+1 at the end of the validation of step N and no longer in a blanket fashion at the start of a cycle. This makes it possible to make use only of the manufacturing-state data necessary for the current step.

In one embodiment, the generating step comprises a step of aggregating the state data of the at least two RFID tags, a step of splitting said state data, and a step of merging the split data to form new data on the manufacturing state of the product.

Thus, the state data are reorganized in the course of the generating step. These data are first aggregated. By “aggregation”, what is meant is the action of uniting distinct elements to form a homogeneous whole. The aggregating step thus corresponds to a concatenating step in which it is possible to identify all the aggregated elements. The aggregated state data are then split, i.e. divided to form split data. These split data are merged to form new data on the manufacturing state of the product. By “merge”, what is meant is the action of uniting distinct elements to form a homogeneous whole in which it is impossible to perceive the origin of the merged data. In these steps, it is possible to perform various operations on the state data, such as operations of complete or partial duplication of the data, etc. The generated new state data are transmitted to the at least two RFID tags.

In one particular embodiment, the new data on the manufacturing state of the product are distributed between the at least two RFID tags.

These new state data are thus divided between various RFID tags, this allowing the overall security of these data to be increased while together recording the state of progress of the manufacture of the product. The computations based on which the data on the manufacturing state of the product are distributed are carried out locally, via local machines or RFID tags, this decreasing the load on corporate servers. Preferably, the same state data are transmitted to both RFID tags. As a variant, different new state data are transmitted to each RFID tag.

In one particular embodiment, the data on the manufacturing state of the product comprise data selected from the list of the following data:
one or more plans;
one or more certificates of conformity;
one or more instruction sheets;
one or more manufacturing results.

In industry, manufacturing processes are based on execution, in production, of manufacturing operations in accordance with a specification file that is a non-exhaustive compilation of data from plans, materials, manufacturing and quality-control tolerances, various instructions, test methods, etc. Production sequences make constant reference to this specification file as production of the product progresses, and a manufacturing file is generated symmetrically, completion of the product being endorsed once these operations have been successfully completed and conformity verified.

In one particular embodiment, the method comprises, prior to the step of transmitting the new data, a step of encrypting said new state data.

Thus, any modification in the data on manufacturing state is reflected in a secure transaction with the RFID tags. This transaction for example uses asymmetric encryption, employing a pair of keys consisting of a private key and a public key. The overall security of the method for sharing data is thus improved.

In one particular embodiment, the method comprises a step of verifying the received state data.

Thus, on each manufacturing operation, the state data are verified. This verification takes place, for example, once state data obtained from various RFID tags have been merged. If one or more RFID tags are inadvertently replaced in the product in the process of being manufactured, the merger of the state data is not compliant and it is recommendable to stop manufacturing to verify the various RFID tags. This state-data verification is also required to avoid any risk in the event of malicious modifications of the state data in the RFID tags during the manufacture of the product.

In one particular embodiment, the new state data are stored in a centralized state-data storage device.

This makes it possible to monitor the various product manufacturing operations centrally.

In one particular embodiment, the new state data are stored in a blockchain.

By blockchain, what is meant is a distributed database secured by cryptographic techniques. The exchanged transactions are grouped into blocks at regular time intervals, thereby forming a blockchain. After recent transactions have been recorded, a new block is generated and analyzed. If the block is valid, it may be timestamped and added to the blockchain. Each block is linked to the previous one by a hash key. Thus, once added to the blockchain, a block may no longer be modified or deleted, this guaranteeing the authenticity and security of the stored data. The blocks of data of the blockchain may be readable and/or writable by entities external to the manufacturing plant. For example, the blocks of data may be consulted by a buyer of the manufactured product wanting to ensure its conformity. Such a buyer will then be able to gain access to details of the various manufacturing operations via the blockchain.

Another subject of the invention is a system for sharing manufacturing data on a product, said product being manufactured from various sub-products in various manufacturing operations. Each sub-product and/or each manufacturing operation is associated with one RFID tag. Each RFID tag contains data on the manufacturing state of the product. The system for sharing data comprises:
a receiver of data on the manufacturing state of the product from the at least two RFID tags;
a generator of new data on the manufacturing state of the product based on said received state data, said received state data being reorganized by said generator;
a transmitter of the new data on the manufacturing state of the product to the at least two RFID tags.

In one particular embodiment, the system comprises a centralized state-data storage device for storing new state data.

In one particular embodiment, the system comprises a blockchain for storing new state data.

Another subject of the invention is a computer program product comprising program instructions that are exploitable by the system for sharing manufacturing data on a product according to the preceding subject, which, when they are executed or interpreted by said system, trigger implementation of the method for sharing manufacturing data on a product according to the other preceding subject.

The present invention will be better understood on reading the detailed description of embodiments, which are given merely by way of non-limiting example, and illustrated by the appended drawings, in which:

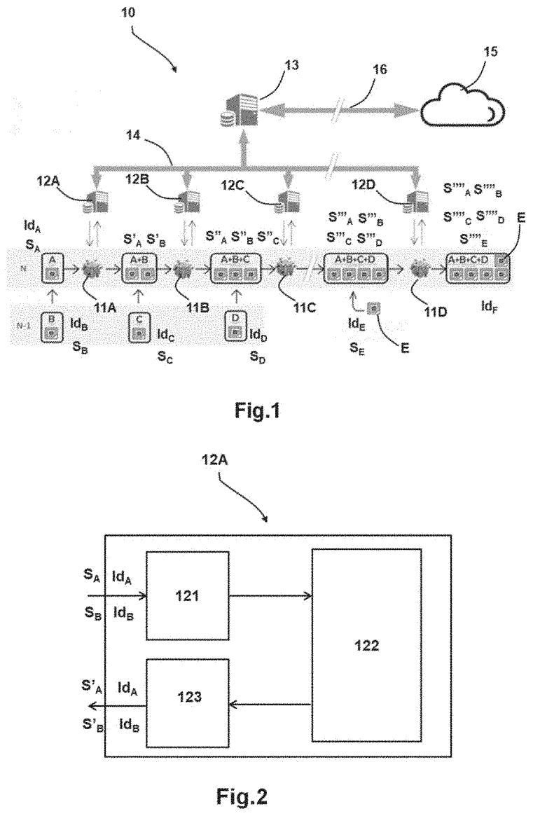

FIG. 1 is a schematic view illustrating a system for sharing manufacturing data on a product according to the invention;

FIG. 2 is a schematic view of a local computer of the system for sharing data of FIG. 1;

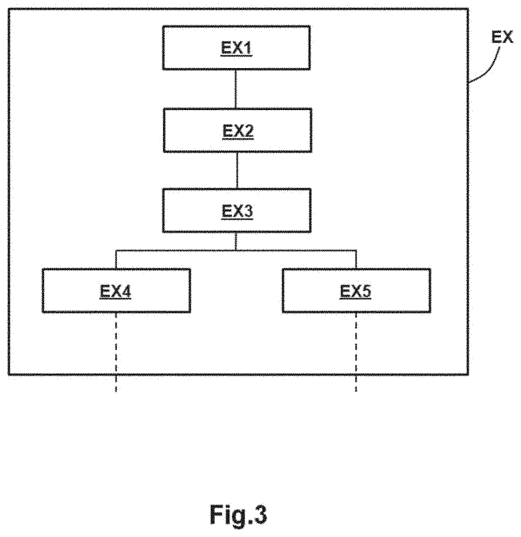

FIG. 3 illustrates one portion of a method for sharing manufacturing data on a product according to the invention.

The invention is not limited to the described embodiments and variants, and other embodiments and variants will seem obvious to those skilled in the art.

In the various figures, identical or similar elements have been designated with the same references.

FIG. 1 schematically shows a system 10 according to the invention for sharing manufacturing data on a product. This system here comprises:
RFID tags A, B, C, D, E;
local machines 11A, 11B, 110, 11D,
local computers 12A, 12B, 12C, 12D;
a central server 13;
a local network 14;
a cloud-computing system 15;
a gateway 16.

The RFID tags A, B, C, D, E are electronic components comprising an antenna and an electronic chip. The antenna is designed to operate in a given frequency band, and for example at a low frequency comprised between 120 kHz and 150 kHz. The electronic chip is connected to the antenna. This chip is intended to store an identifier Id_{A}, Id_{B}, Id_{C}, Id_{D}, Id_{E} associated with each of the RFID tags A, B, C, D, E, respectively. The electronic chip is also suitable for storing data S_{A}, S_{B}, S_{C}, S_{D}; S′_{A}, S′_{B}; S″_{A}, S″_{B}, S″_{C}; S′″_{A}, S′″_{B}, S′″_{C}, S′″_{D}; S_{E}, S″″_{A}, S″″_{B}, S″″_{C}, S″″_{D}, S″″_{E} on the manufacturing state of the product. These state data are modifiable in the RFID tag. It will be noted that since the product is manufactured from various sub-products in various manufacturing operations, each sub-product is associated with one RFID tag A, B, C, D. Similarly, an intangible operation, for example thermal testing or loading of software, may also be associated with an RFID tag E.

The local machines 11A, 11B, 110, 11D are able to read the RFID tags A, B, C, D, E and to extract all or some of the data on the manufacturing state of the product. These local machines 11A, 11B, 110, 11D are also able to write new data on the manufacturing state of the product in place of the state data initially extracted. For example, local machine 11A extracts data S_{A} on manufacturing state from RFID tag A and data S_{B} on manufacturing state from RFID tag B. These data S_{A}, S_{B} on manufacturing state are sent to local computer 12A. In return, local computer 12A provides new state data S′_{A} and S′_{B} which will be written to RFID tag A and to RFID tag B, respectively. The local machines 11A, 11B, 110, 11D also allow various sub-products to be assembled in various manufacturing operations.

The local computers 12A, 12B, 12C, 12D are able to perform operations of aggregating data on the manufacturing state of the product obtained from various RFID tags and operations of merging split data. The merged data are next divided into new data on the manufacturing state of the product, then distributed between the various RFID tags. FIG. 2 more particularly illustrates local computer 12A of FIG. 1. This local computer 12A comprises a receiver 121 of state data S_{A}, S_{B} from RFID tag A and from RFID tag B, respectively. The receiver 121 also receives the identifiers Id_{A}, Id_{B} of the RFID tags A, B. Local computer 12A further comprises a generator 122 of new state data S′_{A}, S′_{B}. As already specified, this generator 122 aggregates the received state data S_{A}, S_{B} then it breaks them up and merges them into new state data S′_{A}, S′_{B}. In one variant embodiment, the aggregated state data are recombined before being broken up. This makes it possible to introduce a certain randomness into the generation of these new state data. The new state data S′_{A}, S′_{B} are associated with the identifiers Id_{A}, Id_{B} of the RFID tags A, B, respectively. Lastly, a transmitter 123 transmits the new state data S′_{A}, S′_{B} to said RFID tags A, B. The description of local computer 12A given with reference to FIG. 2 also applies mutatis mutandis to the other local computers 12B, 12C, 12D.

The central server 13 is able to centralize the data on the manufacturing state of the product. To this end, it comprises suitable storage means. These storage means may thus contain the entire history of the manufacturing process of the product.

The local network 14 allows communication between the local machines 11A, 11B, 110, 11D, the local computers 12A, 12B, 12C, 12D and the central server 13.

The cloud-computing system 15 encompasses all of the accessible computing services provided from outside the manufacturing plant. These computing services are, for example, a service allowing storage on third-party servers, a networking service, a service providing software such as office software, a service providing content, and a service providing Internet access.

The gateway 16 connects the central server 11 to the cloud-computing system 12. It thus allows the local network and the Internet network of the cloud-computing system 15 to be linked. The gateway 16 mainly routes data packets. It may also perform a firewall or proxy function or monitor the quality of service of the network.

A method, according to the invention, for sharing manufacturing data on a product will now be described with reference to FIG. 1 and FIG. 3. The product manufactured here is a computer for acquiring and displaying aircraft data used to actuate the flaps of said aircraft. This acquiring computer comprises a casing, a power supply card, a CPU card (CPU standing for Central Processing Unit), and a graphics card. Each of these sub-components comprises an RFID tag. Thus, the casing is associated with RFID tag A, the power supply card is associated with RFID tag B, the CPU card is associated with RFID tag C, and the graphics card is associated with RFID tag D. RFID tag A contains identifier Id_{A}. RFID tag B contains identifier Id_{B}. RFID tag C contains identifier Id_{C}. RFID tag D contains identifier Id_{D}. An RFID tag E is associated with a salt spray test. This test is carried out once the casing, the power supply card, the CPU card and the graphics card have been assembled. For its part, RFID tag E contains identifier Id_{E}.

FIG. 3 illustrates steps EX1 to EX5, with X comprised between 1 and N, N representing the number of operations (assembly, processing) that the various sub-products will undergo to form the end product. In a first operation E1, the power supply card is assembled with the casing by local machine 11A. The state data S_{A} associated with RFID tag A and the state data S_{B} associated with RFID tag B are transmitted by local machine 11A. In a step E11, these state data S_{A}, S_{B} are received by local computer 12A. In a step E12, new state data S′_{A}, S′_{B} are generated. In a step E13, the new state data S′_{A}, S′_{B} are encrypted. To do this, local computer 12A comprises a private key and local machine 11A comprises a public key associated with said private key. In a step E14, these new state data S′_{A}, S′_{B} are transmitted to local machine 11A. These data are then stored in RFID tags A and B, respectively, in place of the previous state data S_{A}, S_{B}. It will be noted that the new state data S′_{A}, S′_{B} are different from the state data S_{A}, S_{B}. In one particular embodiment, the new state data S′_{A} are identical to the new state data S′_{B}. As a variant, the new state data S′_{A} may be different from the new state data S′_{B}. In parallel, in a step E15, the new state data S′_{A}, S′_{B} are stored in the centralized state-data storage device 13. These new state data S′_{A}, S′are associated, in the centralized storage device 13, with the identifiers Id_{A}, Id_{B} of the RFID tags A, B and with an identifier corresponding to the first operation E1.

The RFID tag attached to each important sub-product of the nomenclature contains, in addition to its conventional data, a set of data related to the manufacturing process, which is characterized by the fact that manufacturing is monitored in the same way as with monitoring software. The traceability and security of production data are thus drastically improved and it is possible, with each transformation of the product, whether said transformation is physical or not, to associate a transformation in the information system, and to ensure products may always be located.

In a second operation E2, the CPU card is assembled with an assembly comprising the power supply card and the casing, by local machine 11B. The state data S′_{A} associated with RFID tag A, the state data SIB associated with RFID tag B and the state data S_{C} associated with RFID tag C are transmitted by local machine 11B. In a step E21, these state data S′_{A}, S′_{B}, S_{C} are received by local computer 12B. In a step E22, new state data S″_{A}, S″_{B}, S″_{C} are generated. In a step E23, the new state data S″_{A}, S″_{B}, S″_{C} are encrypted. To do this, local computer 12B comprises a private key and local machine 11B comprises a public key associated with the private key. In a step E24, these new state data S″_{A}, S″_{B}, S″_{C} are transmitted to local machine 11C. These data are then stored in RFID tags A, B and C, respectively, in place of the previous state data S′_{A}, S′, S_{C}. It will be noted that the new state data S″_{A}, S″_{B}, S_{C}″ are different from the state data S′_{A}, S′_{B}, S_{C}. In one particular embodiment, the new state data S″_{A} are identical to the new state data S″_{B} and S″_{C}. As a variant, the new state data S″_{A} may be different from the new state data S″_{B} and S″_{C}. In parallel, in a step E25, the new state data S″A, S″B, S″c are stored in the centralized state-data storage device 13. These new state data S″_{A}, S″_{B}, S″_{C} are associated, in the centralized storage device 13, with the identifiers Id_{A}, Id_{B}, Id_{C} of the RFID tags A, B, C and with an identifier associated with the second operation E2.

The procedure followed is identical in the third operation E3 and in the fourth operation E4.

Thus, the third operation E3 regards assembly of the graphics card with an assembly comprising the CPU card, the power supply card and the casing, by local machine 11C. New state data S′″_{A}, S′″_{B}, S′″_{C}, S′″_{D} are generated from the state data S″_{A}, S″_{B}, S″_{C}, S_{D} by local computer 12C in various operations E31 to E35. These new state data S′″_{A}, S′″_{B}, S′″_{C}, S′″_{D} are associated, in the centralized storage device 13, with the identifiers Id_{A}, Id_{B}, Id_{C}, Id_{D} of the RFID tags A, B, C, D and with an identifier associated with the third operation E3.

The fourth operation E4 regards a salt spray test carried out, on an assembly comprising the graphics card, the CPU card, the power supply card, and the casing, by local machine 11D. New state data S″″_{A}, S″″_{B}, S″″_{C}, S″″_{D}, S″″_{E} are generated from the state data S′″_{A}, S′″_{B}, S′″_{C}, S′″_{D} by local computer 12D in various operations E41 to E45. These new state data S″″_{A}, S″″_{B}, S″″_{C}, S′″_{D}, S′″_{E} are associated, in the centralized storage device 13, with the identifiers Id_{A}, Id_{B}, Id_{C}, Id_{D}, Id_{E} of the RFID tags A, B, C, D, E and with an identifier of the fourth operation E4.

The end product then comprises RFID tags A, B, C, D, E with the new state data S″″_{A}, S″″_{B}, S″″_{C}, S″″_{D}, S′″_{E}. An identifier Id_{F} is associated with this end product. This identifier Id_{F} is stored in the centralized storage device 13 with the operations E1, E2, E3, E4.

In one preferred embodiment, the state data are verified on receipt thereof by the various local computers 12B, 12C, 12D. For example, it is verified whether the received state data S′_{A}, S′_{B} are identical or compatible with one another. If this is not the case, it is deduced therefrom that one of the RFID tags A, B tags has been modified, intentionally or unintentionally, between the first operation E1 and the second operation E2. Therefore, manufacture of the product must be stopped.

The state data associated with the identifiers of the RFID tags and the identifiers of the various operations may be consulted at any time internally from the centralized storage device 13. These data may also be consulted by people outside the manufacturing plant via the cloud-computing system 15, the gateway 16 and the central server 13 and based on the identifier Id_{F} present on the end product.

In one preferred embodiment, the new state data are stored in a blockchain (not shown in FIG. 1) as the operations E1, E2, E3, E4 progress. This blockchain is accessible by people outside the manufacturing plant via the cloud-computing system 15, the gateway 16 and based on the identifier Id_{F} present on the end product.

Another subject of the invention is a computer program product comprising program instructions that are exploitable by the system 121, 122, 123 for sharing manufacturing data on the end product which, when they are executed or interpreted by this system, trigger implementation of the method for sharing data E1, E2, E3, E4.

The computer program may be stored on a storage medium that is readable by a processor. The medium may be electronic, magnetic, optical or electromagnetic.

In particular, the invention may be implemented by a device comprising a processor and a memory. The processor may be a generic processor, a specific processor, an application-specific integrated circuit (ASIC) or a field-programmable gate array (FPGA).

The device may use one or more dedicated electronic circuits or a general purpose circuit. The technique of the invention may be carried out on a reprogrammable computing machine (a processor or a microcontroller, for example) executing a program comprising a sequence of instructions, or on a dedicated computing machine (for example a set of logic gates such as an FPGA or an ASIC, or any other hardware module).

According to one embodiment, the device comprises at least one computer-readable storage medium (RAM, ROM, EEPROM, flash memory or another memory technology; CD-ROM, DVD or another optical-disc-based medium; magnetic cassette, magnetic tape; non-volatile computer-readable storage disk) encoded with a computer program (i.e. a number of executable instructions) that, when it is executed on one or more processors, performs the functions of the embodiments of the invention described above.

By way of example of a hardware architecture suitable for implementing the invention, a device according to the invention may comprise a communication bus to which are connected a central processing unit or microprocessor, a read-only memory (ROM) which may contain the programs required to implement the invention, a random-access memory (RAM) or cache memory containing registers suitable for storing variables and parameters created and modified during the execution of the aforementioned programs, and a communication or I/O interface (I/O standing for Input/Output) suitable for transmitting and receiving data.

The invention thus makes it possible, based on state data on A on an RFID tag A and on state data on B on an RFID tag B, which are initial components undergoing a production process, to aggregate, split and then merge data obtained from these state data on A and on B, and to redistribute them in an encrypted manner to the storage capacity available at this moment in the process. This storage capacity corresponds to the RFID tags A and B, and hence each tag considered independently does not allow coherent information to be recreated. The security of configuration management and management of all traceability data are improved.

The invention further has the following advantages:
the need for informational transactions with the computer network and monitoring software is limited since the data on manufacturing state are embedded directly into the RFID tags;
resilience to failure of the monitoring software is improved;
it is guaranteed that any physical modification of the product during its manufacture is simultaneously reflected in a secure transaction with the information system;
the configuration of the manufactured product is guaranteed, while data on this configuration are protected by encryption and sharing said information physically between the RFID tags;
any unauthorized intervention on or repair or dismantling of a sub-product results in destruction of or an inability to recover existing information on the product analogously to a tamper-evident label;
the system used to progress production is completely secure and operations that do not involve physical modification (heat treatment, testing, memory loading, etc.) are easily and reliably monitored by encoding performance of these operations in the way described above;
the use of blockchain technologies ensures operations are uniquely linked, configuration control and improved resistance to reverse engineering.

The fact that progress through the manufacturing process is characterized by the addition, on one site, of other sub-assemblies bearing RFID tags allows the security of the associated documentary evidence to be increased by dividing this documentary evidence up and encrypting it on a blockchain.

As a result, progress through the manufacturing process is possible relatively independently of a monitoring system, successful completion of an operation (assembly, testing, etc.) resulting in an unequivocal and systematic transformation of the documentary evidence, and encryption and re-division thereof between the RFID tags attached to the sub-components.

The invention is not limited to the described embodiments and variants, and other embodiments and variants will seem obvious to those skilled in the art.

Thus, the invention is applicable to high-technology fields such as the production of products for aeronautical applications, for space-technology applications or for the medical field, in which fields configuration and traceability are key.

Thus, the invention is applicable to manufacturing processes the supply chain of which is complex or spatially dispersed with attendant problems in locating components.

Thus, reading of the RFID tags in the various local machines allows various sub-products to be located in the process flow.

Thus, all or some of the RFID tags have a distributed computing capacity.

Thus, a merge-encrypt-divide strategy may be applied to any system of collaborative IoT objects (IoT standing for Internet of Things) in which it is sought to secure data and in which the presence of all of the objects is critical to successful completion of a mission or an operation.

Thus, the invention is applicable to any group of communicating objects having a need to operate together (share information) securely and in which it is critical not to lose a component from the chain.

1. A method for sharing manufacturing data on a product, said product being manufactured from various sub-products in various manufacturing operations, each sub-product and/or each manufacturing operation being associated with one RFID tag (A, B, C, D, E), each RFID tag comprising data (S_{A}, S_{B}; S′_{B}, S_{C}; S″_{A}, S″_{B}, S″_{C}, S_{D}; S′″_{A}, S′″_{B}, S′″_{C}, S′″_{D}, S_{E}) on the manufacturing state of the product, during the manufacture of said product said method comprising:
a step (EX1) of receiving data on the manufacturing state of the product from the at least two RFID tags;
a step (EX2) of generating new state data (S′_{A}, S′_{B}; S″_{A}, S″_{B}, S″_{C}; S′″_{A}, S′″_{B}, S′″_{C}, S′″_{D}; S″″_{A}, S″″_{B}, S″″_{C}, S″″_{D}, S″″_{E}) on the manufacturing state of the product based on said received state data (S_{A}, S_{B}; S′_{A}, S′_{B}, S_{C}; S″_{A}, S″_{B}, S″_{C}, S_{D}; S′″_{A}, S′″_{B}, S′″_{C}, S′″_{D}, S_{E}), said received state data being reorganized in said generating step;
a step (EX4) of transmitting the new state data on the manufacturing state of the product to the at least two RFID tags (A, B, C, D, E).

2. The method as claimed in claim 1, wherein the generating step further comprises a step of aggregating the state data (S_{A}, S_{B}, S′_{A}, S′_{B}, S_{C}; S″_{A}, S″_{B}, S″_{C}, S_{D}; S′″_{A}, S′″_{B}, S′″_{C}, S′″_{D}, S_{E}) of the at least two RFID tags, a step of splitting said state data, and a step of merging the split data to form new state data (S′_{A}, S′_{B}; S″_{A}, S″_{B}, S″_{C}; S′″_{A}, S′″_{B}, S′″_{C}, S′″_{D}; S″″_{A}, S″″_{B}, S″″_{C}, S″″_{D}, S″″_{E}) on the manufacturing state of the product.

3. The method as claimed in claim 2, wherein the new state data on the manufacturing state of the product are distributed between the at least two RFID tags.

4. The method as claimed in claim 1, wherein the data on the manufacturing state of the product comprise data selected from:
one or more plans;
one or more certificates of conformity;
one or more instruction sheets;
one or more manufacturing results.

5. The method as claimed in claim 1, wherein said method comprises, prior to the step (EX4) of transmitting the new data, a step (EX3) of encrypting said new stats data.

6. The method as claimed in claim 1, wherein said method comprises a step of verifying the received state data.

7. The method as claimed in claim 1, wherein the new state data are stored (EX5) in a centralized state-data storage device.

8. The method as claimed in claim 1, wherein the new state data are stored in a blockchain.

9. A system for sharing manufacturing data on a product, said product being manufactured from various sub-products in various manufacturing operations, each sub-product and/or each manufacturing operation being associated with one RFID tag, each RFID tag comprising data on the manufacturing state of the product, said data-sharing system comprising:
a receiver of data (S_{A}, S_{B}; S′_{A}, S′_{B}, S_{C}; S″_{A}, S″_{B}, S″_{C}, S_{D}; S′″_{A}, S′″_{B}, S′″_{C}, S′″_{D}, S_{E}) on the manufacturing state of the product from at least two RFID tags;
a generator of new data (S′_{A}, S′_{B}; S″_{A}, S″_{B}, S″_{C}; S′″_{A}, S′″_{B}, S′″_{C}, S′″_{D}; S″″_{A}, S″″_{B}, S″″_{D}, S″″_{E}) on the manufacturing state of the product based on said received state data, said received state data being reorganized by said generator; and
a transmitter of the new data on the manufacturing state of the product to the at least two RFID tags.

10. The system as claimed in claim 9, wherein said system comprises a centralized state-data storage device for storing new state data.

11. The system as claimed in claim 9, wherein said system comprises a blockchain for storing the new state data.

12. A computer program product comprising program instructions that are exploitable by a system for sharing manufacturing data on a product, which, when executed or interpreted by said system, trigger implementation of the method for sharing manufacturing data on said product as claimed in claim 1.
